(19) United States
(12) Patent Application Publication
(10) Pub. No.: US 2004/0100214 A1
(43) Pub. Date: May 27, 2004

(54) Particle accelerator assembly with high power gas target

(76) Inventor: Karl Erdman, Vancouver (CA)

Correspondence Address: PERKINS COIE LLP, PATENT-SEA, P.O. BOX 1247, SEATTLE, WA, 98111-1247, US

(21) Appl. No.: 10/438,258

(22) Filed: May 13, 2003

Related U.S. Application Data
(60) Provisional application No. 60/380,553, filed on May 13, 2002.

(51) Int. Cl. H01J 23/00

(52) U.S. Cl. 315/500

(57) ABSTRACT

The present invention provides systems and methods for the “in-target” reactions of radioisotopes with various reactants in order to form desired reaction products in useful states. One embodiment of the invention provides a target-holding assembly for use with a gas target and a particle accelerator configured to provide a high-energy beam along a beam axis. The target-holding assembly has a mounting portion attachable with the particle accelerator in alignment with the beam axis. A gas target holder is connected to the mounting portion and has a thermally conductive holder body with a target cavity therein configured to be in axial alignment with the beam axis. The target cavity is shaped and sized to fully contain the gas target therein for bombardment by the high-energy beam. The target body has an inlet port in fluid connection with the target cavity. The target body has a cooling channel formed therein adjacent to and isolated from the target cavity, and the cooling channel has an inlet coupleable to a cooling fluid source.

### CROSS-REFERENCE TO RELATED APPLICATIONS

Reference is made and priority claimed to U.S. Provisional Patent Application entitled PARTICLE ACCELERATOR ASSEMBLY WITH HIGH POWER GAS TARGET, filed May 13, 2002, bearing application serial No. 60/380,553, which is incorporated herein by reference.

### TECHNICAL FIELD

The present invention is directed to components for use with particle accelerator assemblies, and more particularly, to target-holding assemblies used in the production of selected radioisotopes.

### BACKGROUND

Biologically active radiochemicals containing radioisotopes have been used for medical research as well as for therapeutic and diagnostic procedures. The incorporation of radioisotopes having short half-lives into a variety of radiochemicals has led to the possibility of imaging and quantifying biological activities in various tissues. The efficacy of the diagnostic procedure is dependent on the specific activity of the radiochemical as well as its purity. In order to produce isotopes of high specific activity, small volume targets of separated isotopes are used in the production processes. The production process for small volumes of separate isotopes can be very expensive. The economic feasibility of the production of the radiochemicals depends on the efficiency of the production process. Targets are necessary that can operate with small volumes of the separated isotopes capable of absorbing high power beams to increase the production rates to acceptable levels. The targets also must allow for efficient removal of the desired radioisotopes after their production.

Various groups have used gaseous targets, in which “in-target” synthesis of radiochemicals or their precursors is conducted. The radioisotope produced during the bombardment of the target material must then be recovered for subsequent use. The use of target holders for gaseous targets on low-energy accelerators, such as the EBCO TR14 cyclotron in which beam currents of protons and deuterons of up to 1 mA are available, raises special problems. Target holder geometries are required that permit their operation when they are bombarded with high power, low-energy beams. The bodies of the target holders must be able to heat up and cool down rapidly to facilitate in target processes that involve a short-lived radioisotope. The target bodies must also be able to withstand the high pressures developed during the bombardment due to beam heating of the gas target. Finally the target holders must be made of materials that do not chemically combine with the isotopes generated in the target holder.

### SUMMARY OF THE INVENTION

The present invention provides an assembly with a target-holding assembly for holding gas targets that overcomes the problems outlined above and experienced in the prior art. One embodiment of the invention provides a target-holding assembly for use with a particle accelerator that provides a high-energy beam along a beam axis. The target-holding assembly has a mounting portion attachable to the particle accelerator in alignment with the beam axis. A gastarget holder is connected to the mounting portion and has a thermally conductive holder body with a target cavity therein configured to be in axial alignment with the beam axis. The target cavity is shaped and sized to fully contain the gas target therein for bombardment by the high-energy beam. The target body has an inlet port in fluid connection with the target cavity. The target body has a cooling channel formed therein adjacent to and isolated from the target cavity, and the cooling channel has an inlet coupleable to a coolant source.

Another embodiment provides a method for forming a radioisotope product within a target vessel. The method includes placing a gaseous target within the target vessel and irradiating the gaseous target within the target vessel to form a radioisotope. A reactant is placed within the target vessel to react with the radioisotope. The reactant reacts with the radioisotope to form the radioisotope product within the target vessel, and the radioisotope product is then removed from the target vessel.

### BRIEF DESCRIPTION OF THE DRAWINGS

FIG. 1 is a schematic representation of a particle accelerator assembly with a target-holding assembly in accordance with an embodiment of the present invention.

FIG. 2 is an enlarged side elevation view of the target-holding assembly of FIG. 1.

FIG. 3 is an enlarged cross-sectional view of the target-holding assembly taken substantially along the lines 3-3 of FIG. 2.

FIG. 4 is an enlarged elevational end view of the target-holding assembly of FIG. 2 viewed from the downstream end of the target-holding assembly.

FIG. 5 is a flow chart diagram illustrating a process for the in-target production of a radioisotope in accordance with one embodiment of the present invention.

### DETAILED DESCRIPTION

In the following detailed description, certain specific details are set forth in order to provide a thorough understanding of various embodiments of the invention. However, one skilled in the art will understand that the invention may be practiced without these specific details. In other instances, well-known structures associated with particle accelerators have not been shown or described in detail to avoid unnecessarily obscuring the description of the embodiments of the invention.

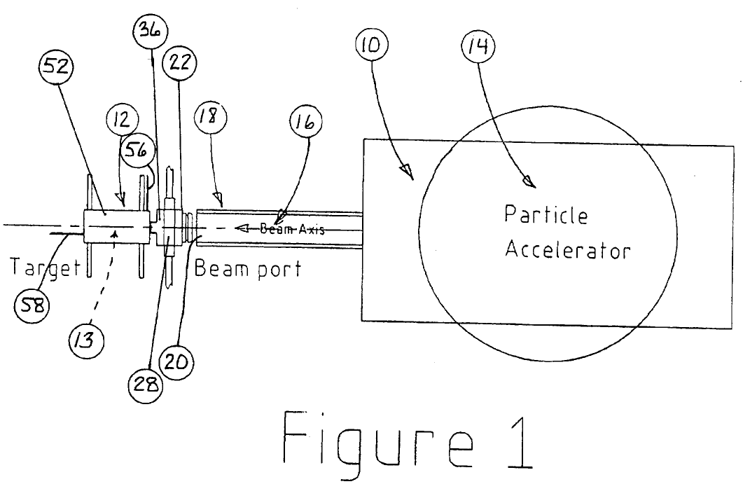

A particle accelerator assembly 10 having a target-holding assembly 12 for holding a gaseous target 13 in accordance with one embodiment of the present invention is illustrated in the figures. As best seen in FIG. 1, the particle accelerator assembly 10 includes a cyclotron 14 that directs a proton beam along a beam axis 16 through an output port 18 to the target-holding assembly 12. The target-holding assembly 12 contains the selected gaseous target 13 in a position to be irradiated by the proton beam to create a selected radioisotope.

In one embodiment, the cyclotron 14 is a negative ion cyclotron, such as the TR19 Cyclotron produced by Ebco Technologies of Richmond, British Columbia, Canada. The TR19 Cyclotron is a low-energy particle accelerator capable of providing proton beams with currents of 100 μA at energies between 13 and 19 MeV. Other low-energy cyclotrons provided by Ebco Technologies provide proton beams with currents in excess of 2 mA on target, which can be ideal for the production of isotopes on solid targets such as Pd-103 for bracchiotherapy. The Ebco Technologies cyclotrons are ideal for the production of radioisotopes such as Carbon-11, Nitrogen-13, Oxygen-15, Fluorine-18 and other short-lived positron-emitting isotopes for the synthesis of various radiochemicals, such as fluorodeoxyglucose (FDG).

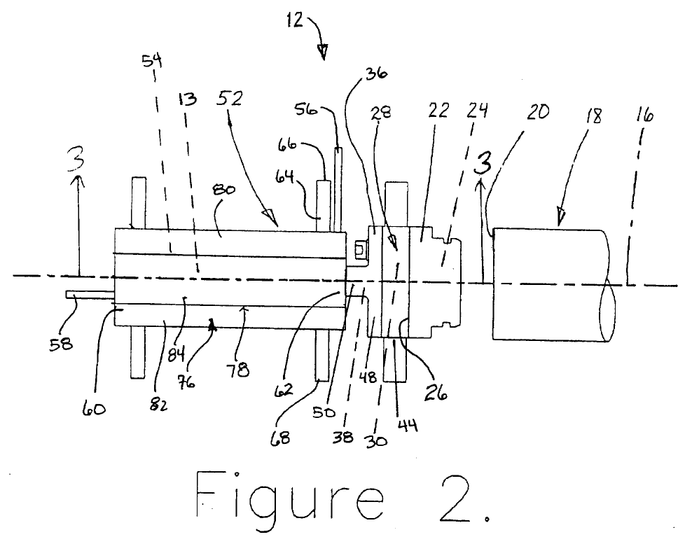

As best seen in FIG. 2, the output port 18 of the cyclotron 14 has a receiving portion 20 that removably retains the target-holding assembly 12 in axial alignment with the beam axis 16. The target-holding assembly 12 has a mounting portion 22 that extends into and connects to the cyclotron's receiving portion 20 in a quick-disconnect manner.

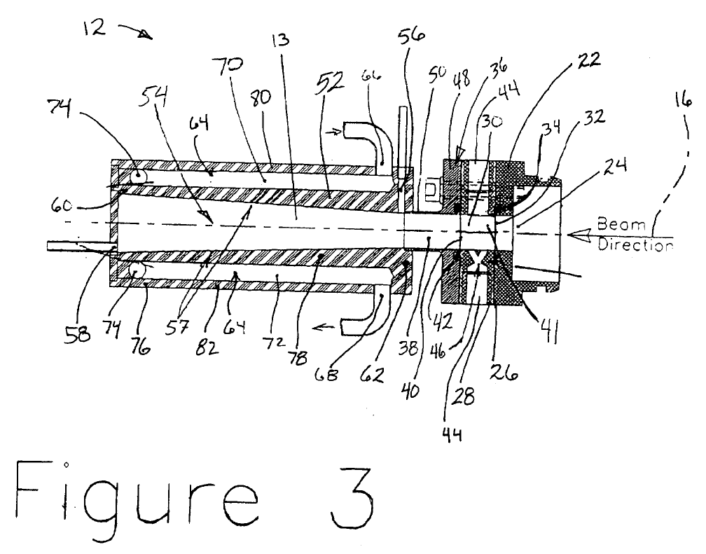

FIG. 3 is an enlarged cross-sectional view of the target-holding assembly 12 taken substantially along line 3-3 of FIG. 2. The mounting portion 22 is a substantially cylindrical member having a central aperture 24 axially aligned with the beam axis 16 and sized so the mounting portion does not interfere with the proton beam passing into the target-holding assembly 12. The mounting portion 22 has a substantially flat engagement surface 26 facing away from the receiving portion 20, and an intermediate flange 28 is securely fastened to the engagement surface 26. The intermediate flange 28 also has a central aperture 30 axially aligned with the mounting portion's central aperture 24 and sized so the intermediate flange does not interfere with the proton beam. In the illustrated embodiment, a first thin, foil window 32 is sandwiched between the intermediate flange 28 and the mounting portion's engagement surface 26 and extends across the central aperture 24. The first foil window 32 provides a thin, yet strong barrier through which the proton beam passes on its way into the target-holding assembly 12. An O-ring 34 is also sandwiched between the intermediate flange 28 and the mounting portion 22 so as to sealably engage the foil window 32 around the central aperture 24. Accordingly, the foil window 32 and the O-ring 34 form a vacuum seal between the mounting portion's central aperture 24 and the intermediate flange's central aperture 30.

The side of the intermediate flange 28 opposite the mounting portion 22 is securely fastened to the entrance flange 36. The entrance flange 36 has a central aperture 38 coaxially aligned with the beam axis 16 and with the other central apertures 24 and 30. In the illustrated embodiment, a second thin, foil window 40 and an O-ring seal 42 are sandwiched between the entrance flange 36 and the intermediate flange 28. The second foil window 40 extends across the entrance flange's central aperture 38 to form a seal between the entrance flange 36 and the intermediate flange 28. The first and second foil windows 32 and 40 are spaced apart to define a sealed separation volume 41 that isolates the cyclotron 14 from the gaseous target 13 contained in the target-holding assembly 12, discussed in greater detail below. In the illustrated embodiment, the foil windows 32 and 40 are made of Havar, which is an inert material having a high tensile strength and a thickness of only 0.001 inch. Alternative embodiments can have foil windows made of other inert materials or of other thicknesses that will withstand the pressures developed in the target-holding assembly 12 while also allowing the proton beam to pass through them without seriously degrading the energy of the beam.

When the proton beam passes through the separation volume 41 and through the first and second foil windows 32 and 40, the foil windows are heated by the proton beam. The intermediate flange 28 has a series of ports 44 coupled to cooling gas connectors 46 that direct a flow of inert cooling gas, such as hydrogen, helium, or argon, into the central aperture 30 of the intermediate flange 28. In the illustrated embodiment, the intermediate flange 28 has six ports 44 in fluid communication with the central aperture 30. The ports 44 direct the inert cooling gas onto the foil windows 32 and 40 to prevent overheating of the windows during proton beam bombardment of the gaseous target 13.

The entrance flange 36 includes a body portion 48 and an integral, thin stainless steel connection tube 50 extending away from the body portion. The body portion 48 engages the intermediate flange 28, and the connection tube 50 is connected to a target body 52 of the target-holding assembly 12. The entrance flange 36, and particularly the stainless steel connection tube 50, helps limit heat transfer from the target body 52 to the intermediate flange 28 and the mounting portion 22 during the irradiation of the gaseous target 13. In the illustrated embodiment, the connection tube 50 has a diameter of approximately 1 cm, a length of approximately 1 cm, and a wall thickness of 0.30 cm, such that the heat conduction from the target body 52 through the connection tube 50 is less than approximately 20 watts when the gaseous target 13 is heated to approximately 500° C. The target body 52 is an elongated, thermally conductive body having an internal, tapered target cavity 54 axially aligned with the connection tube 50 and the beam axis 16. The target cavity 54 has a partial conical shape that tapers radially inwardly from a larger diameter at the distal end 60 of the target body 52 to a smaller diameter at the proximal end 62 adjacent to the entrance flange 36. The tapered shape of the target cavity 54 is configured to accommodate the disbursement of the high-energy beam that occurs when the particle beam bombards the gaseous target 13, thereby allowing for maximum use of the particle beam energy within the target cavity to create a selected radioisotope.

In the illustrated embodiment, the target body 52 is made of copper, which is highly thermally conductive to efficiently carry heat away from the gaseous target 13 when the target is being irradiated. The copper material also allows the target body 52 to quickly cool down or heat up as desired during the process of an in-target reaction, thereby allowing for a quick and efficient recovery of the radioisotopes from the target-holding assembly 12. Alternate embodiments can have a target body 16 made of silver or other material that is highly thermally conductive and chemically inert for selected processes of the in-target reactions.

As best seen in FIG. 3, the target body 52 has an interior surface 56 that defines the target cavity 12. The interior surface 57 of the illustrated embodiment is plated with a thin layer of chemically inert material, such as nickel, that will not affect “in-target” reactions conducted in the target cavity 54. Alternate embodiments, however, can use other chemically inert materials to form the interior surface 57 that defines the tapered target cavity so the interior surface will not chemically react with the gaseous target 13, the radioactive products produced during the bombardment of the gaseous target, or the products of other in-target reactions.

The target body 52 has an inlet port 56 and an outlet port 58 in fluid communication with the target cavity 54. The inlet and outlet ports 56 and 58 are configured to direct the gaseous target 13 or other fluids into and out of the target cavity 54. In the illustrated embodiment, the inlet port 56 extends through the proximal end 62 of the target body 52, and the outlet port 58 is positioned at the distal end 60 of the target body 52. The inlet and outlet ports 56 and 58 in alternate embodiments can be provided at different locations on the target body 52. The inlet and outlet ports 56 and 58 can also be used to direct the gases or liquids into and out of the target cavity 54 for use in the in-target reactions with the radioisotope products of the bombardment.

An example of such a process would be the introduction of a reactant, such as hydrogen (H₂) in helium (He), into the target cavity 54 through the inlet port 56 for the production of HF within the target cavity 54 in which Oxygen-18 (0-18) gas is bombarded to produce the radioisotope Flourine-18 (F-18). Another example of a different process for removal of the radioisotope of Fluorine would be the introduction of water into the target body to wash off the F-18 isotope deposited on the interior surface 57 of the target body 52 defining the target cavity 54. The resulting product from the reactant and the radioisotope can then be easily and quickly removed from the target cavity 54 through the outlet port 58.

When the gaseous target 13 is introduced into the target cavity 54 through the inlet port 56 and bombarded with the proton beam, the temperature of the gaseous target 13 and the target body 52 significantly and quickly increases due to beam heating. This temperature increase is also accompanied by a significant pressure increase in the target cavity 54. It is highly desirable to keep the temperature of the gaseous target 13 and the target body 52 low during the bombardment, and to allow the bombarded gaseous target and target body 52 to cool as quickly as possible for subsequent processing. The thermally conductive copper target body 52 allows for very efficient heat transfer away from the target body by convection. The target body 52 also has cooling channels 64 extending generally adjacent to, yet isolated from, the target cavity 54. The cooling channels 64 are configured to carry a flow of coolant, such as water or other fluid, through the target body 52 adjacent to the target cavity 54 to carry heat away from the target cavity and target body during and after the bombardment process. The cooling channels 64 are coupled to a coolant inlet 66 that directs the coolant into the target body 52, and to a coolant outlet 68 that carries the coolant away from the target body. The coolant works to effectively draw heat out of the target body 52 and the gaseous target 13 in the target holding assembly 12.

In the illustrated embodiment, the cooling channels 64 include a first elongated leg 70 that connects to the coolant inlet 66 and extends along one side of the target body 52 toward the distal end 60. A second elongated leg 72 is on the opposite side of the target body 52 and extends from the target body's distal end 60 to the proximal end 62 and connects to the coolant outlet 68. In one embodiment, the first and second elongated legs 70 and 72 are fluidly connected by an intermediate channel portion 74 that carries the flow of coolant through the distal end portion of the target body 52 from the first elongated leg 70 to the second elongated leg 72. In an alternate embodiment, each of the first and second legs 70 and 72 can be independent channels with its own coolant inlet 66 and coolant outlet 68 so that the flow of coolant through each leg portion can be independently controlled.

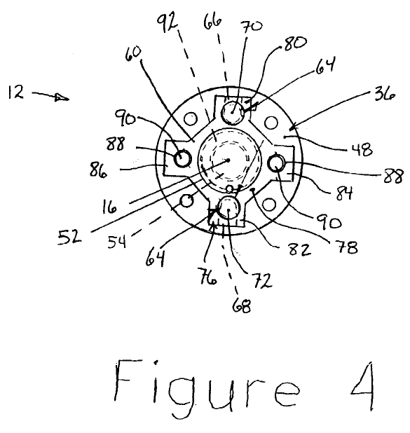

FIG. 4 is an end view of the target-holding assembly 12 of FIG. 3. The target body 52, when viewed from the distal end 60 has four elongated ridge sections 76 arranged generally in a cruciform shape around a central body portion 78 that contains the target cavity 54. The first and second legs 70 and 72 of the cooling channels 64 are bored in two opposing ridges 80 and 82, respectively. The other two opposing ridges 84 and 86 include elongated channels 88 extending substantially adjacent to the target cavity 54 and parallel with the cooling channels 64. The elongated channels 88 of the illustrated embodiment are configured to removably receive thermal elements that provide heating and/or cooling directly to the thermally conductive target body 52. In the illustrated embodiment, the elongated channels 88 are heating channels configured to removably receive resistive heating elements 90 that can quickly heat the target body 52 and the contents in the target cavity 54, such as during an “in-target” reaction that provides the radioisotopes in an easily extractable condition for removal from the target body 52.

In one embodiment a gaseous target 13, such as O-18 gas, is bombarded to create the F-18 isotope, and the F-18 isotope is occluded to the surface 57 of the target cavity 54. The gaseous target 13 and the target body 52 are cooled by the flow of coolant through the cooling channels 64 during the bombardment. Any remaining O-18 (which is very expensive) in the target cavity 54 is easily recovered through the outlet port 58 for use in subsequent applications. Water is then pumped into the target cavity 54 through the inlet port 56. The heating elements 90 in the elongated channels 88 of the target body 52 are activated to quickly heat the water and F-18 isotope. Helium gas is then bubbled via the inlet port 56 through the heated water into the target cavity 54, which creates an in-target reaction with the F-18 isotope, thereby resulting in HF gas that includes the F-18 isotope. The HF gas is then easily removed from the target cavity 54 via the outlet port 58 to readily and efficiently obtain the desired radioisotope in a usable form or for synthesizing to provide a selected radiochemical, such as fluorodeoxyglucose (FDG), for use in medical procedures or the like.

In one embodiment, the cooling channels 64 can also be used to carry heated water or other high-temperature fluids when desired to help heat the target body 52 for the in-target reaction. Alternate embodiments of the target body 52 may have a different number or lengths of channels 64 and 88 for cooling and/or heating of the thermally conductive target body. Such variations may be required to take into account the changing conditions arising as a result of the use of other target gases and of a variety of bombarding particle beams of different energies and intensities.

The illustrated embodiment allows the bombardment of a variety of gases in an efficient and effective manner at relatively high beam currents. The efficient heating and cooling of the target body 52 allows for the filling and emptying of the target cavity 54 with a variety of gases and liquids that will allow various chemical reactions to be carried out in the target body. Heating can facilitate the release of gases such as F2 produced in the bombardment. Heating also permits in-target reactions to be carried out in the target cavity 54 to produce various radioactive compounds such as HF that can be used directly or as precursors in a radiochemical synthesis process.

In accordance with one embodiment, the target-holding assembly 12 (FIG. 1) is designed to enable the bombardment of O-18 gas with beam currents of up to 100 μA in order to achieve a high production rate of F-18 isotope. Such a target-holding assembly 12 requires the ability to operate the target cavity 54 at high pressures to achieve the density necessary to achieve maximum yield of F-18 isotope. Operation at such high pressures would additionally require sufficient cooling of the target body 52 (FIG. 3) to prevent either a further increase in pressure, or a degradation of the integrity of the target cavity 54 (FIG. 3), either of which may increase a risk of failure of the foil window 40 (FIG. 3). Accordingly, sufficient cooling is provided by the flow of coolant through the cooling channels 64 during the bombardment process.

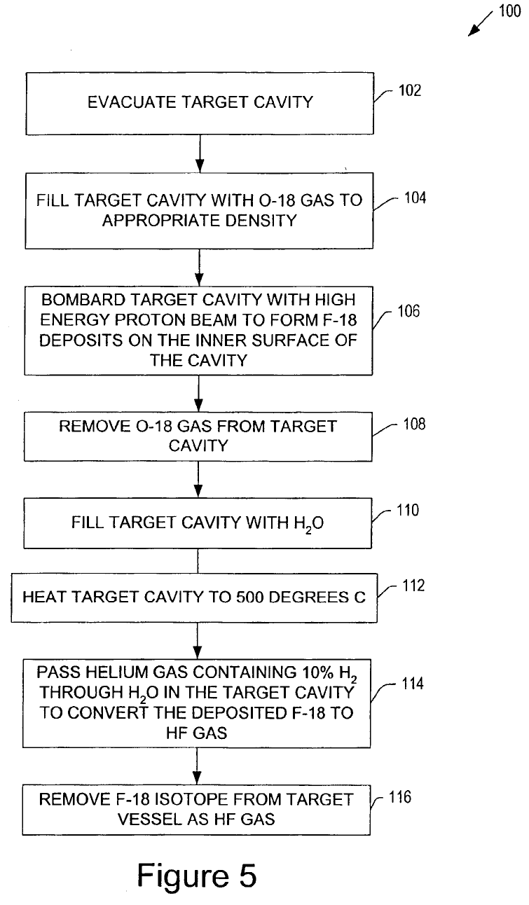

FIG. 5 is a flow chart showing an illustrative process for the in-target production of the F-18 isotope in HF gas. The process includes a step 102 wherein the target cavity 54 (FIG. 3) is evacuated. In step 104, the target cavity 54 (FIG. 3) is filled with O-18 gas to an appropriate density through the inlet port 56 (FIG. 3). In accordance with the present embodiment, an appropriate density of O-18 gas is 1.42·10⁻³ g/cm² for an energy range from the particle beam of 15 MeV. The pressure of the gaseous target 13 will be at least 17 At (250 psig) and the target cavity 54 should be designed to support pressures up to 30 At (450 psig) to allow for the localized heating of the gaseous target 13 during bombardment and resulting decrease in target density. The interior surface 57 (FIG. 3) defining the target cavity 54 is formed by nickel or another inert material suitable for the occlusion of F-18 isotope generated when the O-18 gas is bombarded.

In step 106, the target cavity 54 (FIG. 3) is bombarded by a high energy proton beam along the beam axis 16 resulting in the creation and occlusion of the F-18 isotope on the interior surface 57 (FIG. 3) of the target cavity. In order to achieve a high production rate of F-18 isotope, proton beam energies of 40 to 100 pA should be used in the bombardment. During the bombardment, the temperature of the gaseous target 13 (FIG. 3) will be controlled by the flow of coolant through the cooling channels 64 (FIG. 3) to prevent overheating of the gaseous target and the target body 52. Then in step 108, the O-18 gas remaining in the target cavity 54 (FIG. 3) after bombardment by the proton beam is recovered from the target cavity through the outlet port 58 (FIG. 3). In step 110, the target cavity 54 is then filled with water through the inlet port 56. Then in step 112, the target body 52 (FIG. 3) is heated to approximately 500° C., for example, by using the heating elements 90 removably contained in the elongated channels 88 (FIG. 4).

In step 114, helium (He) gas containing approximately 10% hydrogen (H₂) gas is passed through the water in the target cavity 54 (FIG. 3) to react with the F-18 isotopes on the interior surface 57 defining the target cavity 54 to produce HF gas that includes the F-18 isotope. This “in-target” reaction can be accomplished by bubbling the helium and hydrogen gas through the water in the target cavity 54 (FIG. 3). In step 116, the HF gas containing the F-18 isotope is then removed from the target cavity 54 (FIG. 3) through the outlet port 58. The above exemplary embodiment is only intended to illustrate one possible in-target process. It should be understood that this is just an example of the in-target processes possible with the target-holding assembly 12 of the present invention.

Although specific embodiments of, and examples for, the present invention are described herein for illustrative purposes, various equivalent modifications can be made without departing from the spirit and scope of the invention as can be recognized by those skilled in the relevant art. The teachings provided herein can be applied to other suitable materials and thicknesses, not necessarily the exemplary thicknesses and materials described herein.

I claim:

1. A target-holding assembly for use with a particle accelerator and a gas target, the particle accelerator configured to provide a high-energy beam along a beam axis, comprising:
a mounting portion attachable with the particle accelerator in alignment with the beam axis; and
a gas target holder connected to the mounting portion and having a thermally conductive body with a target cavity therein configured to be in axial alignment with the beam axis and to contain the gas target therein for bombardment by the high-energy beam, the body having an inlet port in fluid connection with the target cavity, the body having a cooling channel formed therein adjacent to and isolated from the target cavity, the cooling channel having an outlet and an inlet coupleable to a source of coolant.

2. The target-holding assembly of claim 1 wherein the cooling channel has first and second portions on substantially opposite sides of the body.

3. The target-holding assembly of claim 1 wherein the cooling channel has substantially opposing first and second portions interconnected by a connection channel portion, the first portion being connected to the inlet and the second portion being connected to the outlet.

4. The target-holding assembly of claim 1 wherein the gas target holder has an outlet port in fluid communication with the target cavity and spaced apart from the inlet port.

5. The target-holding assembly of claim 4 wherein the inlet port is connected to a first end of the target cavity, and the outlet port is connected to a second opposing end of the target cavity.

6. The target-holding assembly of claim 1 wherein the body has an elongated channel adjacent to and isolated from the target cavity, the elongated channel being spaced apart from the cooling channel and configured to removably receive a thermal element therein.

7. The target-holding assembly of claim 1 wherein the body has a plurality of elongated ribs extending radially away from the target cavity, and the cooling channel extends through at least one of the elongated ribs.

8. The target-holding assembly of claim 1 wherein the body has a plurality of elongated ribs extending radially away from the target cavity, and the cooling channel extends through an opposing pair of the elongated ribs.

9. The target-holding assembly of claim 1 wherein the body has a plurality of elongated ribs extending radially away from the target cavity, and the cooling channel extends through two opposing ribs, and a heating channel is formed in another one of the elongated ribs, the heating channel being adjacent to and isolated from the target cavity and being configured to receive a heat source.

10. The target-holding assembly of claim 1 wherein the body has an interior surface formed of an inert material that defines the target cavity.

11. The target-holding assembly of claim 1 wherein the body is copper.

12. The target-holding assembly of claim 1 wherein the target cavity tapers radially inwardly in the direction of the mounting portion.

13. The target-holding assembly of claim 1, further comprising a coupling portion connected to the body and coupled to the mounting portion, the coupling portion has an extended connection tube connected to the body and being made of a material less thermally conductive than the body to at least partially thermally insulate the mounting portion from the body.

14. The target-holding assembly of claim 13 wherein the connection tube is a stainless steel tube coaxially aligned with the target cavity.

15. An system for creating radioisotopes from a gas target, comprising:
a particle accelerator configured to provide a high-energy beam along a beam axis, the particle accelerator having a beam outlet portion; and
a target-holding assembly removably attached to the particle accelerator, the target-holding assembly having a mounting portion releasably coupled to the beam outlet portion of the particle accelerator and in alignment with the beam axis, and a gas target holder is connected to the mounting portion, the gas target holder having a thermally conductive body with a target cavity therein configured to be in axial alignment with the beam axis and to contain the gas target therein for bombardment by the high energy beam, the body having an inlet port in fluid connection with the target cavity, and having a cooling channel formed therein adjacent to and isolated from the target cavity, the cooling channel having an outlet and an inlet coupleable to a cooling fluid source.

16. The system of claim 15 wherein the cooling channel has first and second portions on substantially opposite sides of the body.

17. The system of claim 15 wherein the cooling channel has substantially opposing first and second portions interconnected by an integral connection channel portion, the first portion being connected to the inlet and the second portion being connected to the outlet.

18. The system of claim 15 wherein the gas target holder has an outlet port in fluid communication with the target cavity and spaced apart from the inlet port.

19. The system of claim 18 wherein the inlet port is connected to a first end of the target cavity, and the outlet port is connected to a second opposing end of the target cavity.

20. The system of claim 15 wherein the body has an elongated channel adjacent to and isolated from the target cavity, the elongated channel being spaced apart from the cooling channel and configured to removably receive a thermal element therein.

21. The system of claim 15 wherein the body has a plurality of elongated ribs extending radially away from the target cavity, and the cooling channel extends through at least one of the elongated ribs.

22. The system of claim 15 wherein the body has a plurality of elongated ribs extending radially away from the target cavity, and the cooling channel extends through two opposing ribs, and a heating channel is formed in another one of the elongated ribs, the heating channel being adjacent to and isolated from the target cavity and being configured to receive a heat source.

23. The system of claim 15 wherein the body has an interior surface formed of an inert material that defines the target cavity.

24. The system of claim 15 wherein the target cavity has a tapered shape that tapers radially inwardly in the direction of the mounting portion.

25. The system of claim 15, further comprising a coupling portion connected to the body and coupled to the mounting portion, the coupling portion has an extended connection tube connected to the body and being made of a material less thermally conductive than the body to at least partially thermally insulate the mounting portion from the body.

26. The system of claim 25 wherein the connection tube is a stainless steel tube coaxially aligned with the target cavity.

27. A method for forming a radioisotope product, comprising:
placing a gaseous target within a target-holding assembly having a target cavity therein;
irradiating the gaseous target within the target cavity to form a radioisotope;
placing a reactant within the target cavity after forming the radioisotope;
reacting the reactant with the radioisotope within the target cavity to form a radioisotope product; and
removing the radioisotope product from the target cavity of the target-holding assembly.

28. The method of claim 27, further comprising cooling the target-holder assembly when the gaseous target is being irradiated.

29. The method of claim 27, further comprising directing a flow of cooling fluid through cooling channels in the target holder assembly and cooling the target-holder assembly when the gaseous target is being irradiated.

30. The method of claim 27, further comprising applying a heat source to the target-holder assembly when the reactant is reacting with the radioisotope.

31. The method of claim 27, further comprising placing a heat source in elongated apertures in the target-holding assembly and isolated from the target cavity containing the radioisotope, and heating the target-holder assembly when the reactant is reacting with the radioisotope.

32. The method of claim 27 wherein the target-holder assembly includes an inner surface that defines the target cavity, and reacting the reactant with the radioisotope includes passing the reactant over the inner surface to react with radioisotopes on the inner surface.
